(19) United States
(12) Patent Application Publication
(10) Pub. No.: US 2014/0278634 A1
(43) Pub. Date: Sep. 18, 2014

(54) Spatiotemporal Crowdsourcing

(71) Applicant: Microsoft Corporation, (US)

(72) Inventors: Eric J. Horvitz, Kirkland, WA (US); John C. Krumm, Redmond, WA (US); Semiha E. Kamar Eden, Kirkland, WA (US); Adam Sadilek, Rochester, NY (US)

(73) Assignee: MICROSOFT CORPORATION, Redmond, WA (US)

(21) Appl. No.: 13/831,652

(22) Filed: Mar. 15, 2013

(51) Int. Cl. G06Q 10/06

(52) U.S. Cl. CPC G06Q 10/063112
USPC 705/7.14

(57) ABSTRACT

The subject disclosure is directed towards spatiotemporal crowdsourcing, in which a task including task criteria is received, and an actor set (e.g., human workers) are selected based upon user task preference data and task ability data with respect to accomplishing the task. The actor set is summoned to a location at a time to participate in the task. Spatiotemporal crowdsourcing may be implanted as a service that selects the actor set and tracks state information as to a completion state of the task.

### BACKGROUND

Crowdsourcing generally refers to solving tasks via a large scale community (the “crowd”), relying on people who work remotely and independently via the Internet. Crowdsourcing is based upon the idea that large numbers of individuals often act more effectively and accurately than even the best individual (e.g., an “expert”).

Crowdsourcing tasks are generally computer-based digital tasks, examples of which include text editing, image labeling, speech transcription, language translation, software development, and providing new forms of accessibility for the disabled. Such tasks are intellectual tasks that are accomplished remotely over the Internet, in which workers are generally engaged to participate in task completion independently of one another, often in exchange for compensation or some other reward.

Successes with leveraging the crowd have influenced thinking within a wide range of disciplines, from psychology to machine learning. However, other ways to use the crowd to perform tasks heretofore are not known to have been used.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards spatiotemporal crowdsourcing technology (e.g., implemented as a service) configured to receive a task that includes task-related criteria. The spatiotemporal crowdsourcing service selects an actor set (e.g., one or more human workers and/or entities) for accomplishing the task, including having the task-related criteria and actor-related data used to determine inclusion in the actor set. The spatiotemporal crowdsourcing service summons the actor set to a location at a time, and tracks state information as to a completion state of the task. Note that the actor set may be dynamic, e.g., selection may be ongoing as a task progresses.

In one aspect, there is described receiving a task including task criteria, accessing actor data of one or more actors, including task preference data and task ability data, and selecting an actor set based upon the task criteria and the task preference data and task ability data. The actor set is summoned to a location at a time to participate in the task.

In one aspect, planning a task is described, including arranging task criteria corresponding to the task. Actor-related data is accessed to select an actor set needed for accomplishing the task, including selecting one or more actors until the actor set is sufficient to accomplish the task. The actor set is summoned to accomplish the task, and a completion state of the task is tracked.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram including components configured to provide a spatiotemporal crowdsourcing service, according to one example embodiment.

FIG. 2 is a representation of how spatiotemporal crowdsourcing may be used to route a package or other entity to a fixed or mobile destination, according to one example embodiment.

FIG. 3 is a representation of (at least part of) a routing graph used in spatiotemporal crowdsourcing to route a package or other entity, according to one example embodiment.

FIG. 4 is a flow diagram representing example steps that may be used by spatiotemporal crowdsourcing to perform a task, according to one example embodiment.

FIG. 5 is a block diagram representing an example computing environment, into which aspects of the subject matter described herein may be incorporated.

### DETAILED DESCRIPTION

Various aspects of the technology described herein are generally directed towards accomplishing physical tasks by having actors (e.g., people) collaborate and synchronize in time and physical space (spatiotemporal crowdsourcing) to solve a general class of problems referred to herein as crowdphysics. In general, individuals (and possibly other entities) are summoned to complete a task that involves sensing, solving and/or acting in the physical world. Example crowdphysics problems include tasks such as summoning a team of people to a location to help retrieve a lost item, building a sensor mesh of people to assist in finding a missing child, crowd-powered package delivery, performing a task involving physical (possibly skilled) labor, or to perform any other task that needs the synchronized efforts of multiple actors in space and time. One or more various criteria may be used to select suitable actors to summon.

As used herein, a “task” may be a complete, full task, or may be a task that is actually a subtask of a larger task. For example, a full task may be to deliver a package from person A to person C; however various participants each may be given one task that is only a part, or subtask, of this larger, full task. Thus, for example, a person B may be assigned the task of picking up the package from person A, and delivering the package to person C, which is actually a subtask of the full task.

It should be understood that any of the examples herein are non-limiting. Indeed, various example tasks that may benefit from geospatial crowdsourcing technology are set forth herein, however numerous other tasks may similarly benefit. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in computing and crowdsourcing in general.

FIG. 1 is a block diagram showing example components of an example spatiotemporal crowdsourcing implementation, in the form of a service 102. In general, users 104 register as actors (members) in the spatiotemporal crowdsourcing service via a network (e.g., Internet) interface, shown as coupling to a user task preference and ability component 106.

As part of registration and/or by ongoing updates, each user provides data relevant to task participation, including a user identity and information related to that user's preferences and qualifications with respect to participating in tasks. The preference and qualification information is stored in an actor data store 108, and may include a list of capabilities, competencies and/or experience (e.g., a math tutor for algebra to calculus, five years teaching), price/rate (including overtime), preferences (e.g., evenings OK but not weekends, will work within thirty minutes of a general location), assets e.g., (have a bike or car), calendar data, schedule data and/or possibly other pertinent information. This information may be updated in real time as it changes, either with explicit instructions from the user and/or automatically through sensing and inferernce.

Users are one type of actor that may be summoned to accomplish a task. Although not explicitly shown in FIG. 1, other example types of actors that may have actor data stored in the data store108 include non-human participants, such as a sensor (e.g., as a security camera, traffic camera and/or microphone), an automobile equipped with communication capabilities, tagged equipment, and so forth. An entity such as a truck or airplane thus may be entered into the service 102 as an actor along with its ability data, such as cargo capacity, weight, cost per mile, cost per hour, and so forth. Such other non-human actors may be summoned as part of accomplishing a task, as described below.

Via contemporary computer-aware connectedness, mobile actors also may provide current state information (e.g., via a mobile device application) such as including current GPS coordinates and velocity at a certain sampling rate, and possibly a destination. Thus, for example, a user with a mobile computing device is one such actor whose state information may be useful to the service 102. A non-human mobile actor may likewise provide such state information, e.g., via GPS coordinates and velocity, a nearby truck may be summoned to help accomplish a task, regardless of who is actually driving the truck.

Reputation data may be associated with a user's data, e.g., in the data store 108, such as provided via evaluations, manual ratings, automatic ratings and the like, such as entered by a task owner. A certain reputation measure (e.g., a minimum average rating level) may be specified in the task-related criteria.

Acquaintance data, such as in the form of an acquaintance graph 110, may be available to the service 102, so that, for example, a friend relationship, friend-of-a-friend relationship, or possibly other relationship data may be specified as criteria when summoning workers to accomplish a task. As can be appreciated, acquaintance data among the participants may provide some additional level of reliability and/or trustworthiness to the task owner. For example, a task may specify that anyone participating be a friend, or at least a friend of a friend, or the like. As a more particular example, a task may engage persons A, B and C, in which A is a direct friend of person B, who is a direct friend of person C, even though A and C may have no direct acquaintanceship with each other. In a mesh of people summoned to accomplish a task, the task may specify that every adjacent person (a link) at least be a friend of a friend. However, other tasks can also involve people who are strangers, and who may not even be aware of the other parties in a coordinated task.

FIG. 1 shows a task being received at a planning component 112, in which the task includes any number of criteria. Example criteria include a task deadline, a maximum cost, any reputation requirements, any acquaintance requirements and so on. The cost data may vary with the deadline, e.g., $1,000 if the task is done by midnight tonight, $800 if by tomorrow night. Other criteria may specify a number of workers, skill sets required for the workers, non-human assets needed, and so forth. Basically any task requirement that may be matched against known data regarding actors' preferences and abilities to perform that task may be used as part of the task criteria.

When a task needs to be performed, a subset of one or more actors is summoned by the planning component 112, which in the example of FIG. 1 leverages other components including a task criteria matching module 114 and a payment component 116. In general, the planning component 112 uses the task criteria matching module 114 to work with the preference and ability component 106 to match the criteria associated with the task with an actor set (e.g., one or more users and/or any other actor or actors). Note that the selection of actors for the actor set may be dynamic, e.g., selection may change as a task progresses. For instance, in package delivery, the next carrier may be selected based on who happens to be nearby at a particular time. Similarly, if a larger task is broken up into smaller tasks, or subtasks, each subtask may have an actor set selected for that task at whatever time is appropriate, including dynamically; for example, a single actor may be selected for a subtask such as part of a package delivery, with a next single actor selected (e.g., dynamically based on proximity and availability) for the next subtask part of the delivery, and so on.

The payment component 116 may be used to minimize cost or otherwise meet a budget with respect to the cost of hiring, e.g., by executing a cost function. Filtering may be used to determine the subset of actors for the actor set, and/or a cost function. Bidding or the like may be implemented, e.g., different actors and/or groups may bid on the task. Incentive compatible payment computations (e.g., Vickery-Clark-Groves payments) may be implemented by the payment component to compute payments based on actors' elicited preferences.

By way of example, consider a task that specifies moving one or more items, and is in need of some equipment, such as two forklifts having a certain lifting capacity, and physical labor such as two forklift operators, six laborers each capable of carrying up to 200 pounds, and a supervisor/foreman. The planning component 112 operates in conjunction with the other components 106, 114 and 116 to coordinate the summoning of the equipment and personnel to a specified location at a desired time, based upon who is available, when and where, and their pricing, along with any other criteria such as experience, reputation and so forth. The planning component 112 (or another component of the service 102) may receive task completion state information, to ensure that tasks are completed by the deadline, with any re-planning as needed (e.g., an extra worker is needed). A larger task divided into subtasks may track the task completion state of each subtask, such as to coordinate tasks that need to be done in sequence, as well as ensure that all needed subtasks are completed, (including any subtasks that may be done in parallel). Tasks may be redundantly performed to ensure that at least one instance of a task completes successfully, e.g., having at least one security guard show up is essential, but having two (or even more) is also acceptable.

Note that the task requirements may be specified at least in part directly, and/or the planning component 112 may reason about at least part of the task given indirect information; (e.g., based upon the weight and geometry and number of items that need to be moved, the planning component may compute the number of laborers to summon, the number of forklifts needed, and so forth). Based upon information from the payment component 116, the planning component 112 may determine the cost of performing the task at one time versus another. Further, the planning component 112 may specify that to be hired, each worker needs to confirm that he or she will be at the specified location at the specified time with any specified equipment.

Other examples of crowdphysics tasks that may be performed at least in part using spatiotemporal crowdsourcing include organizing a distributed mesh/lattice of people (and possibly other sensors such as traffic cameras and security cameras), such as for use during an “Amber Alert” to find a missing child. Note that the mesh/lattice may be weighted in some areas more than others, e.g., more participants may be summoned for a busy road than for a less busy road. Another example of a mesh/lattice may be to arrange and direct a search/rescue party to find a lost person or item. State information as to when the task is completed is distributed to the participants so as to stop working on the task.

Still another example of a crowdphysics task that may be solved by the summoning via spatiotemporal crowdsourcing technology include being able to “see”/have a report on some current state of almost anything, on an ad hoc basis. Examples of spatiotemporal crowdsourcing for this purpose including providing a “window to eliminate blind spots,” such as to journalists during civil unrest, to a peacekeeping force in a conflict region, or to protect citizens from an oppressive regime. Spatiotemporal crowdsourcing may be used to coordinate the distribution of supplies or vaccines in times of crisis or a natural disaster, and so forth.

Another crowdphysics problem is reducing traffic congestion. Given a sufficient percentage of participants' locations and velocities, a traffic flow model may be implemented, according to which participants may be notified (e.g., audibly while driving) to get into a certain lane, drive at a certain speed, detour to avoid an accident scene and so forth. Participants may be separately notified of an optimal or advantageous departure time, (e.g., “Based upon traffic, the system recommends leaving no earlier than 5:15 pm”). In addition to better awareness of heavy traffic/problems, and improved traffic flow in general, participants may benefit from a reward system or the like. For example, drivers who comply with suggested speeds, leaving times and so forth may be given money, a discount on tolls, points towards using a carpool lane/high occupancy vehicle (HOV) lane with less than the required number of occupants, insurance discounts and so forth.

As can be seen, spatiotemporal crowdsourcing accomplishes tasks by sequencing or synchronizing physical actions of multiple actors in time and space. This is unlike conventional crowdsourcing tasks in which individuals independently perform computer-based tasks.

By way of another example shown in FIG. 2, consider delivering a package from Point A to Point B via various people traveling between destinations, as represented by arrows labeled one (1) through five (5). The people selected (e.g., from among hundreds or thousands of people moving in the general location) may have different velocities, but are known to intersect within specified time constraints and meet other criteria. Note that points A and B may be fixed or moving targets (as described below). Further note that a package may be any moveable entity, e.g., an actual package, a letter, a passenger, and so forth.

A successful delivery requires a chain of correct handoffs between pairs of workers. Each exchange requires the participants to meet directly or indirectly such as subject to a time constraint (e.g., within thirty minutes); user preference data may also factor into the time constraint, e.g., a user may specify a ten minute wait maximum. Note that the task criteria may specify that the package needs to be personally handed off, or alternatively a worker may leave the package at a (e.g., secure) location for the next worker to pick up and continue the routing process. The task is thus synchronized in time and space.

Further note that another task from within the crowdphysics class of tasks is disease containment. Preventing an outbreak of an infectious disease is analogous to package delivery, with the cost function inverted. The pathogen becomes the package, the contact network is induced from all potential package handoffs, and the function operates to minimize the probability of effective spread. Coordinated crowdphysics tasks may be used to fight the spread of disease by motivating strategically selected people to change their patterns of mobility, including changing the portion of time they stay at home, avoiding global travel of certain types, making substitutions in destinations, and/or avoiding specific venues.

Returning to the package delivery example, a delivery task has multiple locations and times (in contrast to the above-exemplified “moving some items” task that only needed to have a set of workers and equipment arrive at a preset constant location and time). Notwithstanding, a delivery task can be decomposed into a sequence of synchronized summon tasks, namely one task (in this case a subtask) for each handoff, each of which summon two workers (that otherwise match selection criteria) to locations that minimize a given cost function. The cost function can trade off quantities such as task cost, digression of workers from their intended paths or routines, reliability, and speed of task completion.

In a service in which users register to participate and communicate regular coordinates and velocities, a significant amount of spatiotemporal data are available for package routing and delivery. Given a location and velocity of a participant, a path may be predicted; (a participant also may explicitly state a destination). The locations and times of intersecting points are straightforward to compute, and with a sufficiently large number of available participants, a subset that accomplishes the task is highly likely to be found.

By way of example, even without voluntary participants, however, sufficient communication data is available from other sources to demonstrate the computation of such intersecting points. More particularly, when users provide pairs of “tweet” messages that are geo-tagged with GPS coordinates, a large amount of location and velocity information is available. For example, for each pair of consecutive geo-tagged communications (tᵢ, tᵢ₊₁) from a user, the average speed that the user exhibits between the communications may be computed by dividing the geographical distance between the communications by the time difference between timestamps. Note that while such discrete communications constitute a very sparse sample of a person's trajectory, an actual service (e.g., with compensated users) motivates workers to share their location (and possibly velocity and destination) at a higher sampling rate, potentially via an automated heartbeat communication with known fixed or context-sensitive frequency.

With tweets as the geo-tagged communications, filtering may be performed to eliminate data that are clearly anomalous or come from multiple accounts (thus removing likely robot-generated spam). If a user's speed exceeds a certain threshold, communications authored by that user are eliminated from the dataset. The threshold may be set to 80 mph (an upper bound on driving speed) if both tᵢ and tᵢ₊₁ are within the same metropolitan area, and to 600 mph (the high-end of airliner speed) if each comes from a different city. Additionally, user accounts that post duplicate communications (i.e., have identical timestamps and GPS location) may be filtered out. In a service in which users register to participate, e.g., for compensation, additional filtering such as acquaintance requirements, price, preference data (e.g., will not diverge more than a half-mile or wait more than ten minutes) and so forth may be used as filtering criteria.

Networks commonly seen in natural systems involving human activity often exhibit the “small world” phenomenon, where the diameter is O(log n) for networks with n nodes. This means that large networks contain very short (exponentially shorter) paths among pairs of nodes. For a package delivery application, these short paths may be found and leveraged by individual nodes in the network when operating with only local knowledge. The task deals with dynamic, heterogeneous, real-world networks composed of a finite number of mobile individuals.

With the example dataset described above, a routing graph may be generated from user IDs, locations, and timestamps associated with the communications. An efficient graph search method is then used to plan globally optimal package routings, which are in turn leveraged to model the expected performance of the task in terms of delivery times and number of routing hops needed. Thus, in one aspect, crowdphysics tasks may be reduced to a graph planning problem. Results may be based upon actors' actual locations and future locations, and also when routing without global knowledge, making only local greedy decisions.

To construct the routing network from a set of geo-tagged communications, a weighted directed graph G, a routing network, is induced. The i-th tweet of user u is represented as a node tᵢ^{u} in G, and there is a directed edge (tᵢ^{u},tᵢ₊₁^{u}) for pairs of consecutive communications of user u. This is exemplified in FIG. 3 where a routing graph G with two people (user u, black nodes and v, white nodes) are shown, with each node representing a user location at a given time. Edges induce possible paths that a package can follow by connecting consecutive locations of a person (solid edges), and exchange opportunities between people (dashed edges). The edges are weighted by the time it takes to travel between nodes and by wait time.

Thus, each user contributes a directed path (tᵢ^{u}, . . . , t_{N}^{u}) to G where N is the total number of communications written by user u in the data collection period. Every edge (tᵢ^{u},tᵢ₊₁^{u}) is weighted by the time (in seconds) elapsed between posting tᵢ and tᵢ₊₁: w₍ₜ_{ᵤ}_{^{u}}_{, t}_{ᵢ₊₁}_{^{u}}₎=time tᵢ₊₁^{u}−time tᵢ^{u}.

To model package handoffs, edges are added to the routing graph G that denote the potential exchange of a package between two people, where two users “meet” if their geo-tagged communications are within specified distance and time thresholds. More specifically, users u and v may be said to meet if there exist tᵢ^{u} and tⱼ^{v}, such that distance (tᵢ^{u},tⱼ^{v})<δ and |time (tᵢ^{u})−time (tⱼ^{v})|<τ. The parameters δ and τ are variable to provide for the sensitivity of routing performance to increasing the digressions people make from their intended paths or dwell times. Such changes, which might be achieved through selective payments in a real-world system, can lead to routing graphs with target levels of permeability and coverage.

For a given setting of δ and τ, a set of possible exchange edges may be added to G:

{(tᵢ^{u},tⱼ^{v}): distance(tᵢ^{u},tⱼ^{v})<δ [symbol] |time(tᵢ^{u})−time(tⱼ^{v})|<τ}

The weight of these exchange edges is equal to the expected wait time or the time it takes to make the required digression, whichever is greater:

$${w}_{( {t}_{i}^{u} , {t}_{i + 1}^{u} )} = max ( \vert time ( {t}_{i}^{u} ) - time ( {t}_{j}^{v} ) \vert , \frac{distance ( {t}_{i}^{u} , {t}_{j}^{v} )}{1.4 \frac{m}{s}} )$$

where the distance covered is divided by a walking speed of 1.4 m/s to obtain the expected walk time. As a result, the all edges in G are weighted by time (in seconds) that elapsed between the two incident nodes (communications).

At this point, the induction of G is complete and the graph may be used to find an optimal delivery route between any pair of locations by running any shortest-path search algorithm, e.g., Dijkstra's algorithm. The routes found this way are globally optimal, using the available information, and may be used to establish an upper bound on the performance of the package delivery.

Note that in live execution, the system's knowledge may be incomplete, as unless people explicitly provide their destinations, each person's future location is uncertain. Thus, a routing service may use predictions about future behavior, e.g., learned from prior data about the locations of users over time, to determine likely destinations.

Because of the addition of the handoff edges, the delivery times computed using G may be approximate. For instance, allowing a person to wait longer by increasing τ, means that his or her arrival at the next location may be delayed. This may impact the estimate of the delivery time only if the person who is about to pick up the package is required to wait, or if a person participates in multiple adjacent handoffs. Allowing this small imprecision enables planning optimal routes efficiently.

To speed computation time, an algorithm known as “PHAST” may be used to perform a pre-processing step on G after which shortest paths from any node to all other nodes can be computed in O(n) time.

Local opportunistic routing seeks to quantify the gap between theoretically possible delivery times in the system using global search on retrospective data and delivery times that can be realistically expected in a live system operating under uncertainty about the future. To this end, employing local routing policies that may be executed in real time are used, based upon statistics computed from historical data. These statistics are then used in heuristics that guide individuals' real-time routing decisions.

Using historical data, a model of people's location may be used to make routing decisions using only local information. The model of user activity can be made readily available to each worker. To this end, a set of possible delivery locations [symbol] is extracted as the time-stamped locations of the communications in the test set. For each [symbol] ε [symbol] a ranked list of users is constructed based on the distances between them and [symbol] . Users who often appear close to the destination are ranked high, and individuals who spend their time far away are ranked low.

An area may be divided into uniform cells, and for each pair of cells, the routing of packages between the cells is simulated. Every time a person carrying a package encounters another individual, he or she needs to make a routing decision of either keeping the package or handing it off to the other person. A decision is made based on the ranking of the users M who just met (M includes the current carrier as well). Given that the package's destination is [symbol] the next carrier [symbol] is chosen by finding the highest ranked candidate with respect to [symbol] in [symbol] :

$${𝒩}_{closest - point} = {arg max}_{u ∈ ℳ ,} rank ( u , 𝓁 )$$

Note that this algorithm requires only the knowledge of a user's current location, the package destination, and a simple statistic extracted from historical data for each person in the vicinity of a routing point.

Moreover, the distributed delivery methodology enables services that are currently unavailable today, such as dynamic delivery to a specific person. More particularly, instead of routing to a street address as with contemporary delivery services, the crowd may be leveraged to deliver a package or the like to a moving target.

To this end, a recipient's unique identifier may be associated with (e.g., written on) the package, and the package entered into the crowdsource delivery environment. The identifier can be a telephone number, email address, Twitter® handle and so forth. Workers then route the package among themselves until one of them meets the target person. In general, the only constraint in this system is that the package has to be delivered to the recipient as fast as possible; otherwise, the delivery can occur anywhere, anytime. This is somewhat analogous to sending a text message, which quickly reaches the recipient's mobile phone as long as the person is in the coverage area.

However, because packages are physical objects and a person's location is not known ahead of time, computation is needed. To this end, for a user u, take ifs first communication that appears in the data set, namely (t₁^{u}). For the other users v find the fastest path from u to vthrough the routing network G, as before, except that vis a moving target. This is done for all pairs of users:

{(u.v):u,vεU [symbol] u≠v},

where U is the set of all users in the dataset. Delivery is considered successful if there exists a path from u to wand the delivery time is measured from t₁^{u} to the first encounter of u and v, where the package would have been delivered.

FIG. 4 is a flow diagram summarizing some example steps that may be taken by a geospatial crowdsourcing service or the like when a task is received, which may be in real time, or based upon a scheduled task. Step 402 represents arranging the task criteria. For example, if the actor data store is arranged as a data store, an optimized query may be made against the data store to obtain the actor set of actors that meet the criteria. Arranging the task criteria may alternatively (or in addition) include plugging criteria variables into a cost function or the like.

Step 404 represents accessing the actor data store to select actors that meet the criteria. State data also may be accessed, to determine the current state of an actor. This may be via a query or queries, and/or by running the cost function against the data store's data. The actors may be ranked, sorted and so forth, e.g., by reputation and/or cost, or by random or round-robin selection.

Step 406 represents summoning the actor to appear at the specified location at the specified time. If the actor does not confirm (non-human actors may have automated confirmation or a person confirm on their behalf) within a confirmation time, which may vary depending on the actor, that actor is eliminated and another may be chosen. Note that the candidate pool may be larger than the number of actors needed at step 404 so that the query and/or function need not be re-run each time an actor does not confirm in time. Also note that steps 406 and 408 may be run in parallel if multiple actors are needed.

Step 410 evaluates whether the needed actors have confirmed and the summoning is done. The process continues until the needed actors have done so. Note that if the task criteria cannot be met, step 412 represents notifying the owner of the issue.

When the summoning is done and the appropriate actors have confirmed their availability, step 414 represents tracking the task completion state, e.g., versus the deadline, as task state information becomes available. Re-planning may be performed as state information comes in, e.g., the task is behind schedule and the task owner is willing to increase the budget to hire another worker, a confirmed worker did not show up, a piece of equipment broke down, and so forth. Tracking continues until the task is complete, as evaluated at step 416.

As can be seen, crowdsourcing concepts are applied to physical tasks by spatiotemporal crowdsourcing technology. One or more actors are matched to task-related criteria and summoned to accomplish a task, which may be divided into a set of coordinated tasks (subtasks).

### Example Operating Environment

As mentioned, advantageously, the techniques described herein can be applied to any device. It can be understood, therefore, that handheld, portable and other computing devices and computing objects of all kinds are contemplated for use in connection with the various embodiments. Accordingly, the below general purpose remote computer described below in FIG. 5 is but one example of a computing device.

Embodiments can partly be implemented via an operating system, for use by a developer of services for a device or object, and/or included within application software that operates to perform one or more functional aspects of the various embodiments described herein. Software may be described in the general context of computer executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol is considered limiting.

FIG. 5 thus illustrates an example of a suitable computing system environment 500 in which one or aspects of the embodiments described herein can be implemented, although as made clear above, the computing system environment 500 is only one example of a suitable computing environment and is not intended to suggest any limitation as to scope of use or functionality. In addition, the computing system environment 500 is not intended to be interpreted as having any dependency relating to any one or combination of components illustrated in the example computing system environment 500.

With reference to FIG. 5, an example remote device for implementing one or more embodiments includes a general purpose computing device in the form of a computer 510. Components of computer 510 may include, but are not limited to, a processing unit 520, a system memory 530, and a system bus 522 that couples various system components including the system memory to the processing unit 520.

Computer 510 typically includes a variety of computer readable media and can be any available media that can be accessed by computer 510. The system memory 530 may include computer storage media in the form of volatile and/or nonvolatile memory such as read only memory (ROM) and/or random access memory (RAM). By way of example, and not limitation, system memory 530 may also include an operating system, application programs, other program modules, and program data.

A user can enter commands and information into the computer 510 through input devices 540. A monitor or other type of display device is also connected to the system bus 522 via an interface, such as output interface 550. In addition to a monitor, computers can also include other peripheral output devices such as speakers and a printer, which may be connected through output interface 550.

The computer 510 may operate in a networked or distributed environment using logical connections to one or more other remote computers, such as remote computer 570. The remote computer 570 may be a personal computer, a server, a router, a network PC, a peer device or other common network node, or any other remote media consumption or transmission device, and may include any or all of the elements described above relative to the computer 510. The logical connections depicted in FIG. 5 include a network 572, such local area network (LAN) or a wide area network (WAN), but may also include other networks/buses. Such networking environments are commonplace in homes, offices, enterprise-wide computer networks, intranets and the Internet.

As mentioned above, while example embodiments have been described in connection with various computing devices and network architectures, the underlying concepts may be applied to any network system and any computing device or system in which it is desirable to improve efficiency of resource usage.

Also, there are multiple ways to implement the same or similar functionality, e.g., an appropriate API, tool kit, driver code, operating system, control, standalone or downloadable software object, etc. which enables applications and services to take advantage of the techniques provided herein. Thus, embodiments herein are contemplated from the standpoint of an API (or other software object), as well as from a software or hardware object that implements one or more embodiments as described herein. Thus, various embodiments described herein can have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used, for the avoidance of doubt, such terms are intended to be inclusive in a manner similar to the term “comprising” as an open transition word without precluding any additional or other elements when employed in a claim.

As mentioned, the various techniques described herein may be implemented in connection with hardware or software or, where appropriate, with a combination of both. As used herein, the terms “component,” “module,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it can be noted that one or more components may be combined into a single component providing aggregate functionality or divided into several separate sub-components, and that any one or more middle layers, such as a management layer, may be provided to communicatively couple to such sub-components in order to provide integrated functionality. Any components described herein may also interact with one or more other components not specifically described herein but generally known by those of skill in the art.

In view of the example systems described herein, methodologies that may be implemented in accordance with the described subject matter can also be appreciated with reference to the flowcharts of the various figures. While for purposes of simplicity of explanation, the methodologies are shown and described as a series of blocks, it is to be understood and appreciated that the various embodiments are not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, some illustrated blocks are optional in implementing the methodologies described hereinafter.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

In addition to the various embodiments described herein, it is to be understood that other similar embodiments can be used or modifications and additions can be made to the described embodiment(s) for performing the same or equivalent function of the corresponding embodiment(s) without deviating therefrom. Still further, multiple processing chips or multiple devices can share the performance of one or more functions described herein, and similarly, storage can be effected across a plurality of devices. Accordingly, the invention is not to be limited to any single embodiment, but rather is to be construed in breadth, spirit and scope in accordance with the appended claims.

What is claimed is:

1. A method implemented at least in part on at least one processor, comprising, receiving a task including task criteria, accessing actor data of one or more actors, including task preference data and task ability data, selecting an actor set based upon the task criteria and the task preference data and task ability data, and summoning the actor set to a location at a time to participate in the task.

2. The method of claim of claim 1 further comprising receiving state information related to a completion state of the task.

3. The method of claim 1 wherein receiving the task, including task criteria, comprises receiving a task deadline.

4. The method of claim 1 wherein receiving the task, including task criteria, comprises receiving task cost information.

5. The method of claim 1 wherein the actor set includes a plurality of human actors, and wherein receiving the task, including task criteria, comprises receiving at least one acquaintance criterion specifying a relationship between at least two human actors.

6. The method of claim 1 wherein the actor set includes one or more human actors, and wherein receiving the task, including task criteria, comprises receiving at least one reputation criterion specifying a desired reputation measure of the one or more human actors.

7. The method of claim 1 further comprising, receiving state information corresponding to a current state of an actor, and wherein selecting the actor set further comprises using the state information.

8. The method of claim 7 wherein the state information includes location data and velocity data of an actor, and wherein using the state information comprises predicting a future location of the actor based at least in part on the location data and the velocity data.

9. The method of claim 1 wherein the task criteria includes task-related time data, wherein the task preference data includes availability time data of an actor, and wherein selecting the actor set comprises eliminating the actor from inclusion in the actor set based upon the task-related time data and the availability time data of the actor.

10. The method of claim 1 wherein the task criteria includes skill-related task data, wherein the task ability data includes a skill set of an actor, and wherein selecting the actor set comprises including the actor in the actor set based upon matching the skill-related task data with the skill set of the actor.

11. The method of claim 1 wherein the task criteria includes task cost data, wherein the task preference data includes data corresponding to a cost of an actor, and wherein selecting the actor set comprises eliminating the actor from inclusion in the actor set based upon task cost data and the data corresponding to the cost of the actor.

12. The method of claim 1 wherein the task comprises a selected subtask of a plurality of subtasks of a larger task, and wherein summoning the actor set to a location at a time to participate in the task comprises summoning the actor set to complete the selected subtask.

13. A system comprising, one or more processors, a memory communicatively coupled to the processor, and a spatiotemporal crowdsourcing configured to execute on the one or more processors from memory, the spatiotemporal crowdsourcing service configured to receive a task that includes task-related criteria, and to a) operate to select an actor set for accomplishing the task, including to have the task-related criteria and actor-related data used to determine inclusion in the actor set, b) summon the actor set to a location at a time, and c) track state information as to a completion state of the task.

14. The system of claim 13 wherein the actor set includes at least one human actor and at least one non-human actor.

15. The system of claim 13 wherein the actor-related data comprises preference data of a human actor, ability data of a human actor, or both preference data and ability data of a human actor.

16. The system of claim 13 wherein the task-related criteria includes time-related data and cost-related data.

17. The system of claim 13 wherein the task comprises arranging a mesh of actors to provide information, coordinating actions of a plurality of actors, or coordinating two actors in space and time to transport an entity from one actor to another actor.

18. The system of claim 13 wherein the spatiotemporal crowdsourcing service executes a cost function to select the actor set.

19. One or more computer-readable media having computer-executable instructions, which when executed on at least one processor perform steps, comprising:
planning a task, including arranging task criteria task corresponding to the task;
accessing actor-related data to select an actor set needed for accomplishing the task, including selecting one or more actors until the actor set is sufficient to accomplish the task;
summoning the actor set to accomplish the task; and
tracking a completion state of the task.

20. The one or more computer-readable media of claim 19 having computer-executable instructions comprising, re-planning the task based upon the completion state of the task, including selecting at least one other actor to accomplish the task.
